(19) United States
(12) Patent Application Publication
(10) Pub. No.: US 2015/0015128 A1
(43) Pub. Date: Jan. 15, 2015

(54) CONFIGURABLE SYSTEM FOR CORRUGATED STORAGE CONTAINERS

(71) Applicant: FELLOWES, INC., Itasca, IL (US)

(72) Inventors: Tai Hoon Matlin, Round Lake Beach, IL (US); Shawn Applegate, Wood Dale, IL (US)

(21) Appl. No.: 14/330,698

(22) Filed: Jul. 14, 2014

Related U.S. Application Data
(60) Provisional application No. 61/845,857, filed on Jul. 12, 2013.

(51) Int. Cl. A47B 47/06; B23P 19/00

(52) U.S. Cl. CPC A47B 47/06; B23P 19/00
USPC 312/111; 29/525.01

(57) ABSTRACT

The present application provides a system that includes a storage container system, at least one additional element, and one or more connector members for connecting the at least one additional element and the storage container system. The storage container system includes a drawer sleeve and a storage box slideably received in the drawer sleeve. The at least one additional element is selected from the group consisting of a second said storage container system, an exterior panel, or a bottom support panel. Each connector member includes a U-shaped body having spaced-apart first and second members for receiving portions of walls of the at least one additional element and the drawer sleeve of the storage container system therebetween.

### CROSS-REFERENCE TO RELATED APPLICATIONS

This patent application relies on the benefit under 35 U.S.C. §119(e) of U.S. Provisional Patent Application Ser. No. 61/845,857, filed on Jul. 12, 2013, which is incorporated herein by reference in its entirety.

### FIELD

The present patent application relates to storage containers, in particular corrugated storage systems and or semi-permanent furniture items.

### BACKGROUND

### Description of Related Art

As the need for inexpensive, flexible semi-permanent storage system increases due to document storage regulations, the need to efficiently store documents and organize items within the home, home office and work environment has increased.

Typically storage container systems that use corrugated material have a lift off lid and are stacked on top of one another to fully utilize available storage space. Within this type of storage category, there has been a need for storage drawer systems or stacking storage cubes which allow direct access to the article being stored more conveniently. As these storage drawer type systems are stacked upon one another, due to the lightweight construction of the corrugated material, the stacked organizing storage drawers or cubes tend to move around as to make this type of storage container systems not as effective as it can be.

Prior attempts to lock these types of storage container systems in place, such as tape, double stick tape, glue, and Velcro are ineffective or inflexible as a solution. All of these can be used to interlock the storage container systems, but each of them has certain weaknesses. For example, tape, double stick tape and glue when used, only allow for the permanent configuration of the storage container system. Once stacked and taped or glued together, un-stacking the storage container system may permanently damage or scar the surface of the corrugated or porous material. Velcro or similar types of methods allow for un-stacking and reconfiguring, but additional pads of Velcro may be needed for each reconfiguration and the non-used Velcro elements need to remain on the storage container system since the attempted removal of the Velcro may permanently damage or scar the surface of the corrugated or porous material.

According to a conventional solution, a device is provided which can be used with storage container systems, such as a corrugated drawer storage system, which allows users to easily stack, add more and or reconfigure the stacked assembly to fit a particular need without destroying, scaring or damaging the drawer storage system each time the user wants to reconfigure the storage configuration. Such a solution uses an exterior skeleton on the outer drawer sleeve of the drawer storage system to allow each drawer and sleeve to be stacked one upon another and when needed, un-stacked. This method is both expensive and affects the appearance of the storage drawer system (as it is exposed on the outside of the drawer storage system), which in some cases would be undesirable.

For example, FIG. 1 illustrates an exemplary conventional stacking drawer storage system 100. This type of system 100 uses outer skeletal support members 102 as the keying members for stacking drawer systems 110 and 112 and stabilizing them as an inner drawer 104 is being pulled out of an outer drawer sleeve 106. Generally, the construction on the stacking drawer storage system 100 in FIG. 1 uses the same type of material, corrugated paper based fluted material that is standard in the industry.

A modular system which allows the user to quickly assemble, arrange and rearrange their storage system accommodating for the needed adaptability as their storage needs change over time is desirable.

### SUMMARY

In one embodiment of the present patent application, a system that includes a storage container system, at least one additional element, and one or more connector members for connecting the at least one additional element and the storage container system is provided. The storage container system includes a drawer sleeve and a storage box slideably received in the drawer sleeve. The at least one additional element is selected from the group consisting of a second said storage container system, an exterior panel, or a bottom support panel. Each connector member includes a U-shaped body having spaced-apart first and second members for receiving portions of walls of the at least one additional element and the drawer sleeve of the storage container system therebetween.

In another embodiment of the present patent application, a method for connecting a storage container system comprising a drawer sleeve and a storage box slideably received in the drawer sleeve and at least one additional element selected from the group consisting of a second said storage container system, an exterior panel, or a bottom support panel is provided. The method includes connecting the at least one additional element and the storage container system using one or more connector members. Each connector member includes a U-shaped body having spaced-apart first and second member. The connecting includes positioning each connector member such that the first and second members are configured to receive portions of walls of the at least one additional element and the drawer sleeve of the storage container system therebetween.

In yet another embodiment of the present patent application, a system that includes a storage container system, at least one additional element, and one or more connector members for connecting the at least one additional element and the storage container system is provided. The storage container system includes a sleeve. The at least one additional element is selected from the group consisting of a second said storage container system, an exterior panel, or a bottom support panel. Each connector member includes a U-shaped body having spaced-apart first and second members for receiving portions of walls of the at least one additional element and the sleeve of the storage container system therebetween.

Other aspects, features, and advantages of the present patent application will become apparent from the following detailed description, the accompanying drawings, and the appended claims.

### BRIEF DESCRIPTION OF THE DRAWINGS

Various embodiments are disclosed, by way of example only, with reference to the accompanying schematic drawings in which corresponding reference symbols indicate corresponding parts, in which

FIG. 1 shows a perspective view of a storage container system with a prior art system for connecting two storage container system with an inset showing two storage container systems being connected to each other using the prior art connecting system;

FIG. 2 shows perspective views of corrugated panel members used for forming storage container systems in accordance with an embodiment of the present patent application;

FIGS. 3 and 3A show a front view and a right side view of a connector member for connecting a panel member or a storage container system with another storage container system in accordance with an embodiment of the present patent application;

FIG. 3B shows a cross-sectional view, taken along an axis A-A, of the connector member of FIG. 3;

FIGS. 4A, 4C, 4E and 4G show views of different panel members before being connected by the connector member(s), while FIGS. 4B, 4D, 4F, and 4H show the same views of corresponding panel members after being connected by the connector member(s) in accordance with an embodiment of the present patent application;

FIGS. 5A and 5C show perspective views of two storage container systems before being connected by the connector member(s), while FIGS. 5B and 5D show the same perspective views of the two storage container systems after being connected by the connector member(s) in accordance with an embodiment of the present patent application;

FIGS. 6A and 6B show front views of a top panel member, a base panel member with casters, a storage container system and connector members before and after assembly, respectively, in accordance with an embodiment of the present patent application;

FIG. 6C shows a front view of a stacked, assembled storage container system in which a top panel member, a base panel member with casters, and two storage container systems are all connected using the connector members in accordance with an embodiment of the present patent application;

FIGS. 7, 7B and 8 show perspective views of a stacked storage container system with a top panel member and a base panel member with casters all connected using the connector members (before and after the assembly) in accordance with an embodiment of the present patent application; and

FIGS. 9A-9C and 10 show front views of different stacked storage container systems with top panel members and base panel members (with or without casters) all connected using the connector members in accordance with an embodiment of the present patent application.

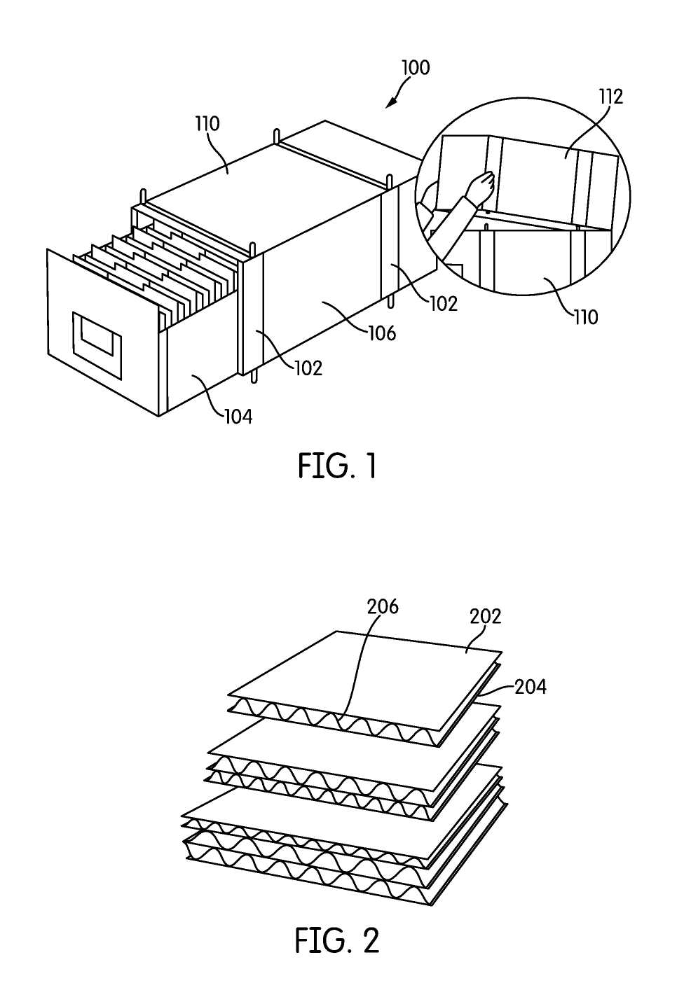

### DETAILED DESCRIPTION OF THE DRAWINGS

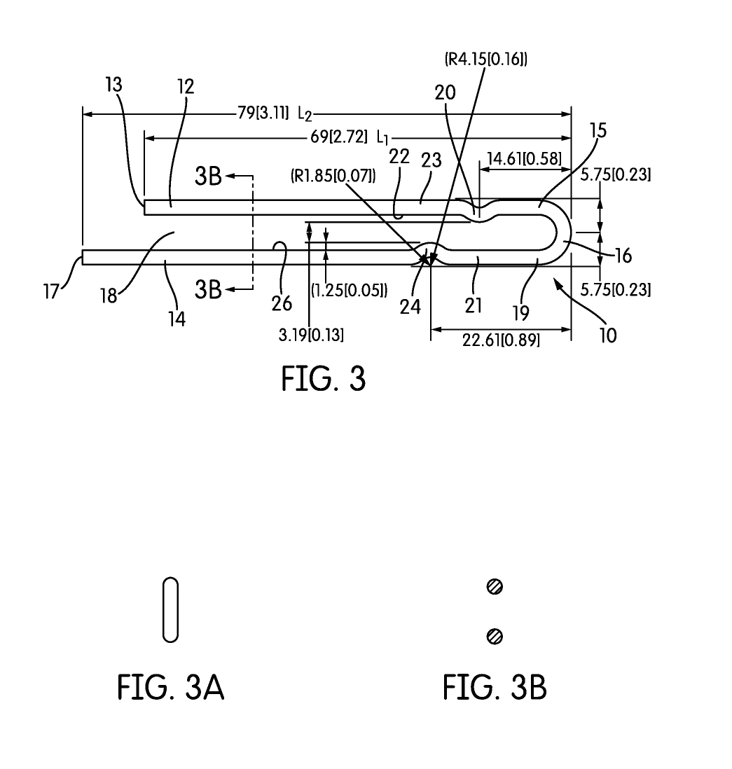

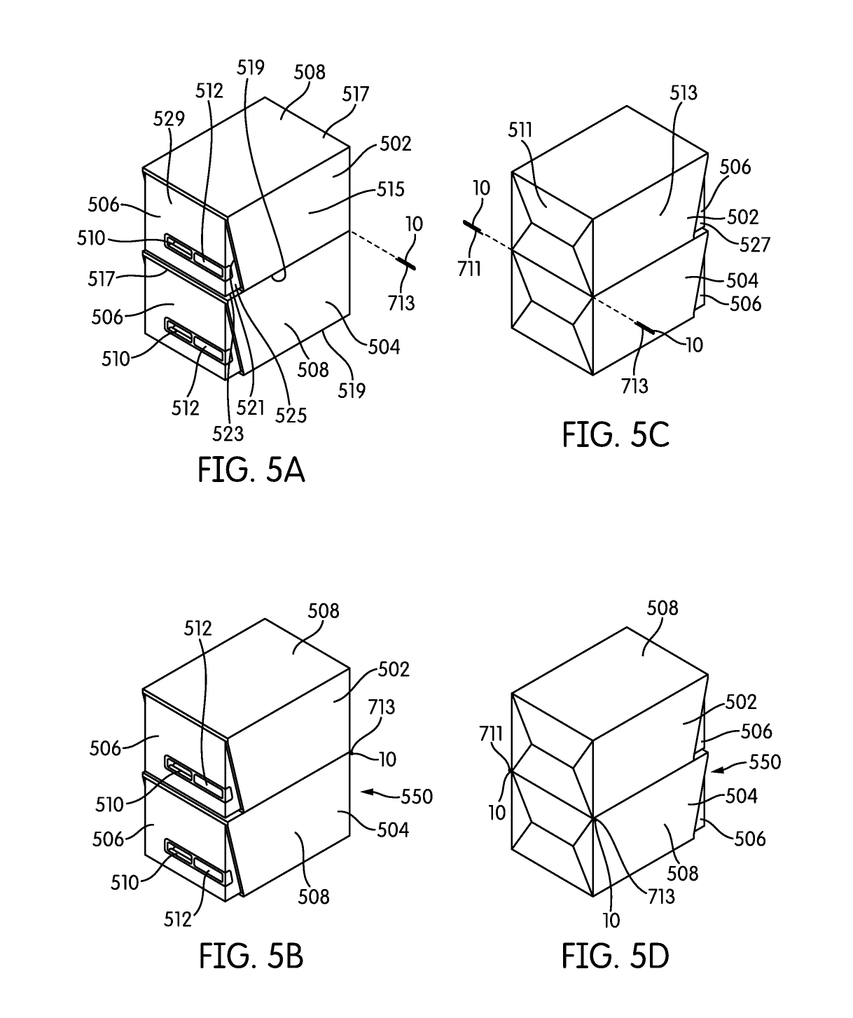

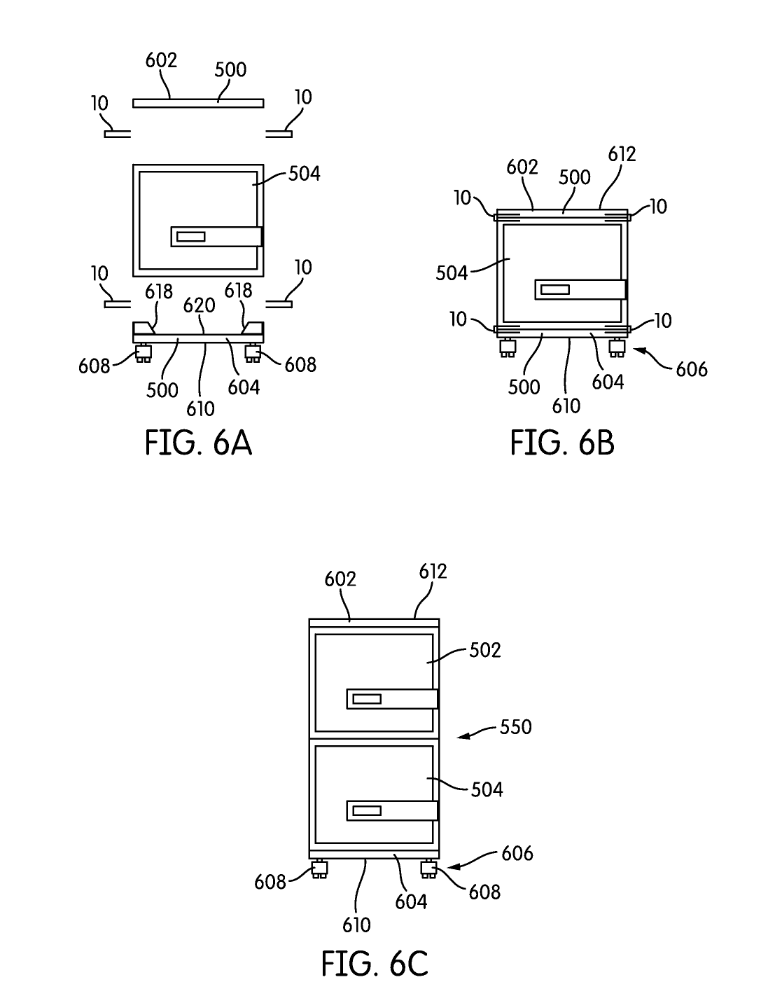

The present patent application provides a simple, reconfigurable assembly device to be used with storage container systems such as stackable drawer systems. The device may include a clip element or connector member 10 (as shown in FIG. 3) that may be applied post assembly, without having to disassemble the storage container systems 502 or 504 (as shown in FIGS. 5A-6C). The device is also configured to prevent permanent damage or scarring of the surface of the corrugated or porous material of the storage container systems 502 or 504 when the storage container systems are reconfigured. As described in the present disclosure, such a clip element 10 may provide the additional benefit of accommodating additional accessories (e.g., top 602 or base (with or without casters) 604, as shown in FIGS. 6A-6C) which may be added to the storage container system assembly 502 or 504.

An embodiment of the connector member 10 is illustrated in FIG. 3. Referring to FIGS. 3-3B and 5A-8, one or more connector members 10 are configured for connecting at least one additional element 500 or 502 and a storage container system 504. As shown in and explained with respect to FIGS. 6A-8, the at least one additional element 500 or 502 may be selected from the group consisting of a second said storage container system 502, an exterior panel 602, or a bottom support panel 604. The exterior panel may be a top exterior panel 602.

As shown in and explained with respect to FIGS. 5A-5D, each storage container system 502 or 504 includes a drawer sleeve 508 and a storage box 506 slideably received in the drawer sleeve 508. In another embodiment, the storage container system may include a five sided sleeve member (i.e., without a storage box received therein). For example, the five sided sleeve member may include a top wall, a rear/back wall, a bottom wall, and two opposing side walls. The walls of the five sided sleeve member define a storage space with a front opening to receive documents or other contents or items or articles therein.

The panel member 500 and the storage container system 502 or 504 may be made from a corrugated material, a porous material, a celled material, a fluted material, a pierceable material, or any other compressible material. For example, such a material may be constructed from a variety of substances and may have a variety of structures, as are commonly known in the container art. As shown in FIG. 2, corrugated material is generally constructed of two or more layers 202 and 204 of linerboard sandwiching one or more layers of a fluted material 206. The linerboard and fluted material are commonly fiber materials. However, non-fiber corrugated materials, such as plastics and polyethylene may also be used. The corrugations may run parallel to a longitudinal direction. The panel member 500 and the storage container system 502 or 504 may be may be constructed of any material that may form a stiff panel surface. Generally, any such material (e.g., as shown in FIG. 2) that has some flexibility may be used interchangeably in the construction of the stacking storage container system assembly and may work with the clip element 10 of the present disclosure.

Referring to FIGS. 3-3B, the connector member 10 includes a first elongated member 12 having proximal and distal end portions 13 and 15, a second elongated member 14 having proximal and distal end portions 17 and 19, and a connector portion 16 (also called a bight) for connecting the first elongated member 12 and the second elongated member 14 at their distal end portions 15 and 19.

The first and second elongated members 12 and 14 are spaced-apart from each other to define a space 18 therebetween for receiving portions of walls of the panel member 500 or the storage container system 502 and the storage container system 504. The first and second elongated members 12 and 14 may be parallel to each other. The first elongated member 12, the second elongated member 14 and the connector portion 16 may be integrally formed as a U-shaped body. The connector member 10 may be shaped and constructed differently as long as it configured to connect the panel member 500 or the storage container system 502 and the storage container system 504.

The connector member 10 is made from a carbon steel material. The connector member 10 is made from a carbon steel wire. The connector member 10 may be made from any material that has some resiliency to return to its original shape even after being stressed and pulled outwards or apart during its application.

The length of one of the first elongated member 12 and the second elongated member 14 is shorter than length of other of the first elongated member 12 and the second elongated member 14. For example, in the illustrated embodiment of FIG. 3, the first elongated member 12 has a length L₁ and is shorter than the second elongated member 14 having the length L₂. This configuration of one of the ends of the first elongated member 12 and the second elongated member 14 being shorter allows for easier insertion of the connector member 10 into the material (of the panel member 500 or the container storage system 502 and the container storage system 504) being clipped together.

The proximal end portions 13 and 17 of the connector member 10 have flat configuration that make it easier to push the connector member 10 into place. As shown in FIG. 3B, the connector member 10 may have a circular shaped cross-sectional configuration. However, it is contemplated that the connector member 10 may have any other shaped cross-sectional configuration as long as it is configured to connect the panel member 500 or the storage container system 502 with the storage container system 504. Also, as shown in FIGS. 3 and 3B, the connector member 10 has a uniform cross-sectional configuration throughout.

The first elongated member 12 includes a protruding portion 20 disposed on an inner surface 22 thereof. The protruding portion 20 is configured to apply clamping force on the portions of the walls of the panel member 500 or the storage container system 502 and the storage container system 504 received between the protruding portion 20 of the first elongated member 12 and the second elongated member 14. The first protruding portion 20 is disposed near the distal end portion 15 of the first elongated member 12. The second elongated member 14 may include a flat, non-protruding portion 21 opposite the protruding portion 20 such that the protruding portion 20 is configured to apply clamping force on the portions of the walls of the panel member 500 or the storage container system 502 and the storage container system 504 received between the protruding portion 20 of the first elongated member 12 and the non-protruding portion 21 of the second elongated member 14.

The second elongated member 14 includes a second protruding portion 24 disposed on a second inner surface 26 thereof. The second protruding portion 24 is configured to apply clamping force on the portions of the walls of the panel member 500 or the storage container system 502 and the storage container system 504 received between the second protruding portion 24 of the second elongated member 14 and the first elongated member 12. The second protruding portion 24 is disposed near the distal end portion 19 of the second elongated member 14. The first elongated member 12 includes a flat, non-protruding portion 23 opposite the second protruding portion 24 such that the second protruding portion 24 is configured to apply clamping force on the portions of the walls of the panel member 500 and the storage container system 504 received between the second protruding portion 24 of the second elongated member 14 and the non-protruding portion 23 of the first elongated member 12.

The first or second protruding portion 20 or 24 may be referred to a constricting bump element. The constricting bump element(s) configured to pinch the clipped material together with more force. In another embodiment, both the second protruding portion 24 and the first protruding portion 20 may be disposed opposite to each other such that both the second protruding portion 24 and the first protruding portion 20 are configured to apply clamping force from opposing sides on the portions of the walls of the panel member 500 or the storage container system 502 and the storage container system 504 received between the second protruding portion 24 of the second elongated member 14 and the first protruding portion 20 of the first elongated member 12.

Corrugated, fluted or cellular material constructed storage container systems 502 or 504 may be die-cut flat and then assembled, with their shape held together by a series of or combination of tabs, folds, and glued joints. The material, since it has fluted voids, may compress to allow the connector member 10 to lock two thicknesses (of the panel member 500 or the storage container system 502 and the storage container system 504) together. For example, the connector member 10 may interlock two wall thicknesses (of the panel member 500 or the storage container system 502 and the storage container system 504) of the storage container system together by compressing them at the restriction point (i.e., protruding portion 20 or 24) of the connector member 10.

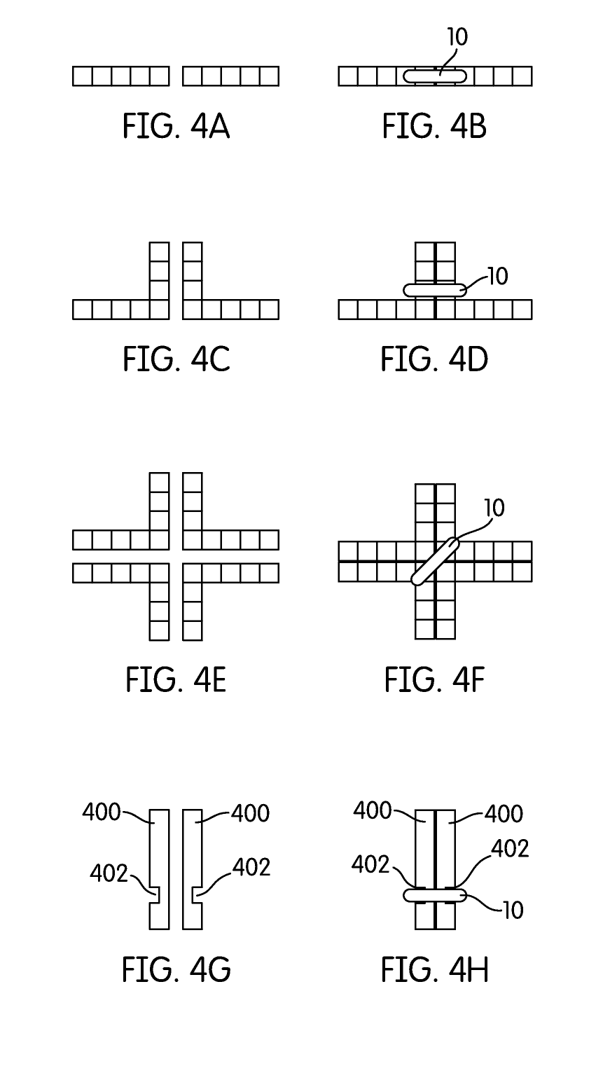

FIGS. 4A-H illustrate a variety of different configurations and mating possibilities in which the connector member 10 may be used to configure and stack the storage container systems. For example, FIGS. 4A, 4C, 4E and 4G show views of different panel members before being connected by the connector member(s) 10, while FIGS. 4B, 4D, 4F, and 4H show the same views of the corresponding panel members after being connected by the connector member(s) 10. That is, FIGS. 4B, 4D, 4F, and 4H show how the clip element 10 functions to link or connect the corrugated elements or panel members together.

For example, FIG. 4A shows two corrugated elements or panel members (or two fluted sheets) being disposed edge to edge (or side-by-side relationship), while FIG. 4B shows the two corrugated elements or panel members (or two fluted sheets) being connected to each other by the connector member 10. FIG. 4C shows two folded corners or flaps of two corrugated elements (or two fluted sheets) being disposed next to each other, while FIG. 4D shows the two corrugated elements (or two fluted sheets) being connected to each other by the connector member 10. FIG. 4E shows four folded corner (corner folds) or flaps of four corrugated elements (or four fluted sheets) being disposed next to each other, while FIG. 4F shows the four corrugated elements (or four fluted sheets) being connected together by the connector member 10. As shown in FIGS. 4A-4F, the (elongated members of the) connector member 10 may be disposed horizontally or at any angle to connect the corrugated elements or panel members together. The (elongated members of the) connector member 10 may also be disposed vertically to connect two container storage systems that are disposed on top of each other (as shown in FIGS. 5A-5D).

FIGS. 4G and 4H illustrate a configuration where the connector member 10 may be applied to a non-fluted material 400 by forming or machining a cored or notch out detail 402 in which the connector member 10 may be received. That is, FIGS. 4G and 4H show how a solid material (i.e., non-fluted material) may be detailed so as to function with the connector member 10. For example, the panel members 400 may include receiving portions 402 that are configured to receive the first member 12 and the second member 14 of the connector member 10.

As the connector member 10 may be applied to interlock two fluted or porous wall thicknesses together, it may be appreciated that the connector member 10 may be applied to construct a stacked assembly of the storage container systems without having to disassemble any of the storage container systems.

The panel member 500 may be configured to be part of another storage container system 502. For example, FIGS. 5A and 5C illustrate two stacked drawer storage container systems 502 and 504 and the possible connector member placements so as to interlock the storage container systems 502 and 504 together and FIGS. 5B and 5D illustrate the assembled storage container system 550 with the connector members 10 installed. As shown, minimally visual clips may have little or no impact to the appearance of the assembled, stacked storage container system 550.

As shown in FIGS. 5A-5D, the storage container system 502 or 504 may be a drawer storage system having the storage box or drawer 506 (i.e., a storage box with an open top) and the drawer sleeve member or outer sleeve member 508 configured to receive the drawer 506 therein. Both the drawer 506 and the outer sleeve member 508 are configured so that the drawer 506 may slide or be moved forwardly or backwardly into and out of the outer sleeve member 508. The outer sleeve member 508 may generally include a rear wall 511, opposing side walls 513 and 515, a top wall 517, a bottom wall 519. The walls of the outer sleeve member 508 are configured form a drawer space with a front opening 521 to receive the drawer 506 therein. The drawer 506 may include a bottom wall 523, opposing side walls 525 and 527, a rear wall (not shown), and a front wall 529. The walls of the drawer 506 are configured form a receiving space with a top opening to receive documents or other contents or items or articles therein.

The connector member 10 is configured to connect with portions of walls of the the outer sleeve member 508 of the storage container system 502 or 504 to connect the storage container system 502 or 504 with the panel member 502 or the other storage container 504 or 502. For example, the connector member 10 is configured to connect with the top wall 517 of the storage container system 502 when connecting the storage container system 502 with the top panel member 602 or with the storage container system 504 disposed on top of the storage container system 502. The connector member 10 is configured to connect with the bottom wall 519 of the storage container system 502 when connecting the storage container system 502 with a bottom panel member 604 or with the storage container system 504 disposed below the storage container system 502. The connector member 10 is configured to connect with the side wall 513 or 515 of the storage container system 502 when connecting the storage container system 502 with the storage container system 504 disposed side-by-side relationship with the storage container system 502.

Each drawer 506 is provided with a handle member 510 so that the drawer 506 may easily be gripped by the handle member 510 and moved forwardly or backwardly into and out of the outer sleeve member 508. The drawer 506 may also include a place holder 512 in the front wall 529 thereof that is configured to receive a label or card to identify the contents stored in the drawer 506.

Referring to the FIGS. 5A-5D, two vertically stacked (i.e., vertically on top of each other) drawer storage container systems 502 and 504 are assembled together using two connector members 711 and 713. Each connector member 10 may be disposed such that it is received by the bottom panel member 519 of the outer sleeve member 508 of the top storage container system 502 and the top panel member 517 of the outer sleeve member 508 of the top storage container system 504. The connector member 10 is configured to interlock two wall thicknesses (of the bottom panel member 519 of the outer sleeve member 508 of the top storage container system 502 and the top panel member 517 of the outer sleeve member 508 of the top storage container system 504) of the storage container system together by compressing them at the restriction point (i.e., protruding portion 20 or 24) of the connector member 10.

The connector member(s) 10 may also be used to assemble two horizontally disposed (i.e., in a side-by-side relationship, next to each other) drawer storage container systems. In such an embodiment, each connector member 10 may be disposed such that it is received by the side panel member of the outer sleeve member of the first storage container system and the side panel member of the outer sleeve member of the second storage container system. The connector member 10 is configured to interlock two wall thicknesses (of the side panel members of the outer sleeve members of the first and the second storage container systems) of the storage container system together by compressing them at the restriction point (i.e., protruding portion 20 or 24) of the connector member 10.

The connector member 10 may also allow for additional elements to be clipped into place in addition to connecting the storage container systems together. For example, the panel member 500 may be the top panel member 602 and/or the bottom panel member 604 (with or without caster assembly 606). Referring to FIGS. 6A-8, The connector member 10 may be used to connect the top panel member 602 and/or bottom panel member 604 (with or without caster assembly 606) to the storage container system 504 or to a stacked, assembled container storage system 550 (in which the storage container systems 502 and 504 are assembled together with the connector members 10).

Referring to FIGS. 6A-8, the rigid molded top panel member 602 may be configured to hold heavy objects, such as coffee cups, for example. The rigid top panel member 602 may also act as a protective surface against impact and moisture, and may be designed to be easily cleaned. This top panel member 602 may be clipped to the assembly 504 or 550 using the same modular clips 10. The top panel member 602 may have a protective coating layer on a surface 612 and may include one or more recesses on the surface 612 to receive items or objects therein or to receive magnetic or suction elements therein so as to secure the items or objects to the surface 612 of the top panel member 602.

The connector member(s) 10 may be used to assemble the top panel member 602 to the storage container system 504 or a stacked, assembled container storage system 550. In such an embodiment, the connector member 10 may be disposed such that it is received by the top panel member 602 and the top panel member of the outer sleeve member of the storage container system 504 or 550. The connector member 10 is configured to interlock two wall thicknesses (of the top panel member 602 and the top panel member of the outer sleeve member of the storage container system) together by compressing them at the restriction point (i.e., protruding portion 20 or 24) of the connector member 10. For example, one of the distal ends of the clip 10 may be pressed into the fold or crease of the assembled storage container system 504 or 550 and the other distal end of the clip 10 into an intentional opening or relief detail in the top panel member 602 so as to interlock the top panel member 602 to the storage container system 504 or 550 as shown in FIGS. 6B, 6C, 7, 7B and 8.

Additionally, FIGS. 6A-8 show an embodiment of an optional base assembly component and how it is clipped onto the storage container system using the connector member 10. The base panel member 604 may include connecting members 618 disposed on its surface 620.

The connector member(s) 10 may be used to assemble the bottom panel member 604 to the storage container system 504 or a stacked, assembled container storage system 550. In such an embodiment, the connector member 10 may be disposed such that it is received by the connecting member 618 of the bottom panel member 604 and the bottom panel member of the outer sleeve member of the storage container system 504 or 550. The connector member 10 is configured to interlock two wall thicknesses (of the connecting member 618 of the bottom panel member 604 and the bottom panel member of the outer sleeve member of the storage container system 504 or 550) together by compressing them at the restriction point (i.e., protruding portion 20 or 24) of the connector member 10. For example, in a similar manner as the top panel member 602 was assembled to the storage container system 550 or 504, one of the distal ends of the clip 10 may be pressed into the fold or crease of the assembled storage container system 550 or 504 and the other distal end of the clip 10 into an intentional opening or relief detail in the base panel member 604 as to interlock the base panel member 604 to the storage container system 550 or 504.

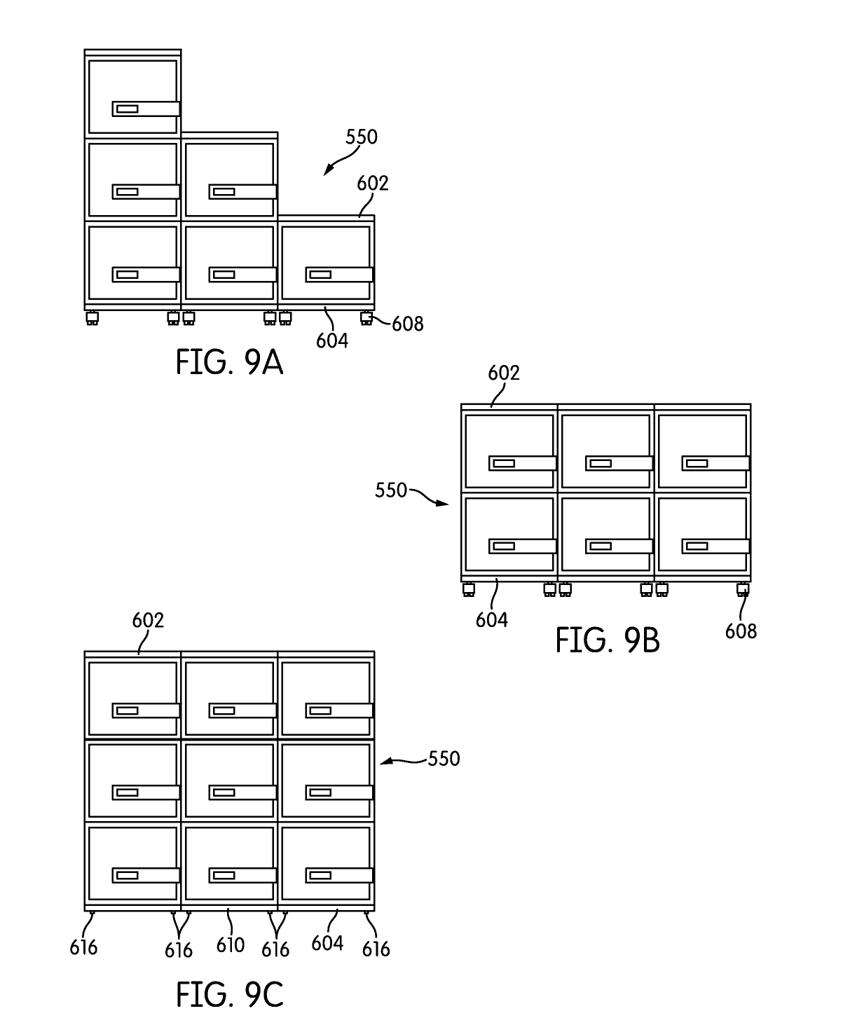

The bottom panel member 604 may include caster assembly 606 (with casters 608) connected to a surface 610 the bottom panel member 604 and configured for rolling the assembled storage container system 504 or 550 across a surface in any direction. That is, the caster assembly 606 may function as to add mobility to the stacked storage assembled storage container system 504 or 550. In another embodiment, the bottom panel member 604 may not include caster assembly 606 and may instead include members 616 (FIG. 9C) on the surface 610 that are configured to provide a raised platform configuration (e.g., as shown in FIG. 9C) to the assembled storage container system 504 or 550 when the assembled storage container system 504 or 550 is disposed on a surface. The raised platform configuration may protect the assembled storage container system 504 or 550 from moisture by lifting the assembled storage container system 504 or 550 off the floor/surface, such as shown in the embodiment of FIG. 9C. This raised platform configuration may also allow the assembled storage container system 504 or 550 to be placed into areas that are typically unfriendly to a corrugated storage container due to the floor being exposed to a higher level of moisture, such as due to cleaning or environmental reasons.

Both the hard top panel member 602 and the raised base panel member 604, with or without casters 608, may interlock to each other, as shown in the embodiment of FIG. 10, and may create a continuous surface or top if desired, and or a continuous base or bottom as to create a solid (e.g., strong/rigid) locked assembly.

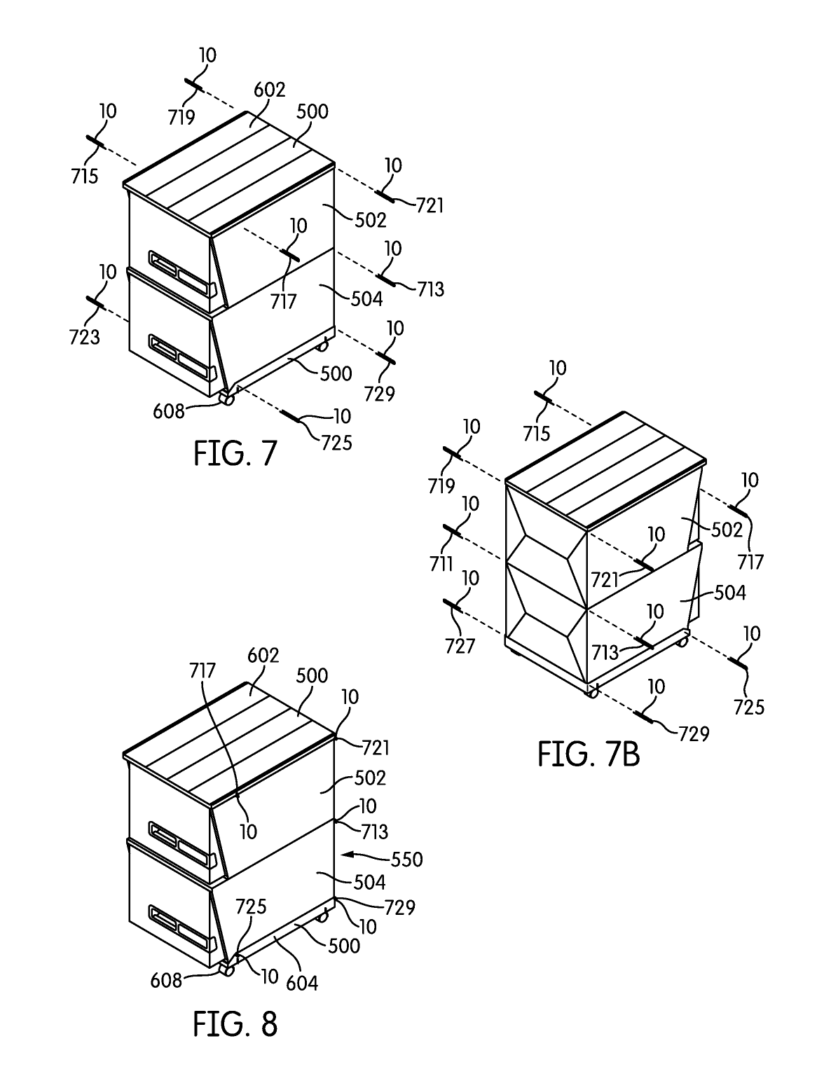

Referring to FIGS. 7-8, two vertically stacked (i.e., on top of each other) drawer storage container systems 502 and 504 are assembled together to form stacked assembly storage container system 550 using two connector members 711 and 713. The top panel member 602 is connected to the top storage container system 502 using four connector members 715, 717, 719 and 721 and the bottom panel member 604 is connected to the bottom storage container 504 using four connector members 723, 725, 727, and 729. As discussed above, the storage container system 502 and the second storage container system 504 may be disposed horizontally next to each other (in a side-by-side relationship) and are then connected to each other to form the assembled storage container system.

The flexibility the clip system with the interchange components may allow for many different configurations. This is useful since the storage system may be configured and reconfigured per a specific need or for a particular environment. Different configurations, such as in FIGS. 9A-C, illustrate how the storage container systems may be stacked using a multitude of clips 10 and if so desired, the accessories such as the modular hard surface top 602 and/or the caster base 604 as shown in FIGS. 6, 7 and 8. The use of the clip 10 to assemble additional accessories is not limited to just the accessories described in this application. Additional accessories such as dividing systems (e.g., within the drawer) and items such as magazine holders on the outside of the storage container system, and a bridging table top assembly which may allow the components to be configured as a desk, are only some of the unique elements that may be added using the modular clip design in some embodiments. The accessory items listed are exemplary, and other accessories may additionally or alternatively be utilized.

It may be appreciated that the ability to stack and secure the storage container system using the clip 10 may give the system the flexibility to fit into today's business environments and to create many different type of temporary furniture based units and assemblies. From a two drawer filing cabinet like storage device as in FIGS. 5A-8 to a more complex and larger assembly as in FIGS. 9A-10, the interlocking system may in some embodiments incorporate a finished feel, look and use, and may allow for the creation of a unique storage container system and other possible furniture based elements that can be configured and reconfigured to fit the complex storage and temporary furniture needs of today's home, home office and business environments.

FIGS. 5B, 5D, 6B, 6C, 8, 9A-10 show how the clips 10 do not impact the look of the design while giving the storage container assembly the needed rigidity by interconnecting all the elements.

Thus, an assembly system for corrugated constructed storage drawer system typically used to store documents within the office, home or home office is disclosed. The storage container, assembly clip (which allows for re-configuration of the storage components even after the initial assembly) and useful accessories which give the storage container system a finished and functional appearance make up this uniquely adaptable storage container system. The system of the present disclosure may be applied to a variety of semi-temporary storage system or any other structural furniture item that uses hollow (fluted) or porous materials as its main construction material.

The word corrugated as used in the present patent disclosure should not be construed as limiting and the corrugated material of the present patent disclosure may be substituted with any porous, hollow, compressible, fluted or pierce-able material.

The foregoing illustrated embodiments have been provided to illustrate the structural and functional principles of the present patent disclosure and are not intended to be limiting. To the contrary, the present patent disclosure is intended to encompass all modifications, alterations and substitutions within the spirit and scope of the appended claims.

What is claimed is:

1. A system comprising:
a storage container system comprising a drawer sleeve and a storage box slideably received in the drawer sleeve;
at least one additional element selected from the group consisting of a second said storage container system, an exterior panel, or a bottom support panel; and
one or more connector members for connecting the at least one additional element and the storage container system, each connector member comprising:
a U-shaped body having spaced-apart first and second members for receiving portions of walls of the at least one additional element and the drawer sleeve of the storage container system therebetween.

2. The system of claim 1, wherein the first member comprises a protruding portion disposed on an inner surface thereof, and wherein the protruding portion is configured to apply clamping force on the portions of the walls of the at least one additional element and the drawer sleeve of the storage container system received between the protruding portion of the first member and the second member.

3. The system of claim 2, wherein the second member comprises a second protruding portion disposed on a second inner surface thereof, and wherein the second protruding portion is configured to apply clamping force on the portions of the walls of the at least one additional element and the drawer sleeve of the storage container system received between the second protruding portion of the second member and the first member.

4. The system of claim 2, wherein the additional element is a second said storage container system, wherein the storage container system and the second storage container system are connected to each other form an assembled set of storage container systems.

5. The system of claim 4, wherein the storage container system and the second storage container system are disposed horizontally next to each other and are then connected to each other to form the assembled set of storage container systems.

6. The system of claim 4, wherein the storage container system and the second storage container system are disposed vertically on top of each other and are then connected to each other to form the assembled set of storage container systems.

7. The system of claim 4, further comprising a top exterior panel and one or more additional said connector members for connecting the exterior top panel, wherein the one or more additional connector members are configured to connect the top exterior panel to a top wall of at least one drawer sleeve of the assembled storage container system.

8. The system of claim 7, further comprising a bottom support panel and one or more additional connector members for connecting the bottom support panel, wherein the one or more additional connector members are configured to connect the bottom support panel to a bottom wall of at least one drawer sleeve of the assembled set of storage container systems.

9. The system of claim 8, further comprising casters connected to the bottom support panel for rolling the assembled set of storage container systems across a surface.

10. The system of claim 4, further comprising a bottom support panel and one or more additional connector members for connecting the bottom support panel, wherein the one or more additional connector members are configured to connect the bottom support panel to a bottom wall of at least one drawer sleeve of the assembled set of storage container systems.

11. The system of claim 10, further comprising casters connected to the bottom support panel for rolling the assembled set of storage container systems across a surface.

12. The system of claim 1, wherein the walls of the storage container system and the at least one additional element each comprises receiving portions configured to receive the first member and the second member of the connector member.

13. The connector member of claim 1, wherein the walls of the storage container system and the at least one additional element are made from a corrugated material, a porous material, a celled material, a fluted material, a pierceable material, or a compressible material.

14. A method for connecting a storage container system comprising a drawer sleeve and a storage box slideably received in the drawer sleeve and at least one additional element selected from the group consisting of a second said storage container system, an exterior panel, or a bottom support panel, the method comprising:
connecting the at least one additional element and the storage container system using one or more connector members, each connector member comprising a U-shaped body spaced-apart first and second member, the connecting comprises
positioning each connector member such that the first and second members of the connector member are configured to receive portions of walls of the at least one additional element and the drawer sleeve of the storage container system therebetween.

15. The method of claim 14, wherein the connecting further comprises applying clamping force, by a protruding portion of the first member, on the portions of the walls of the at least one additional element and the drawer sleeve of the storage container system received between the protruding portion of the first member and the second member.

16. The method of claim 15, wherein the connecting further comprises applying clamping force, by a protruding portion of the second member, on the portions of the walls of the at least one additional element and the drawer sleeve of the storage container system received between the protruding portion of the second member and the first member.

17. A system comprising:
a storage container system comprising a sleeve;
at least one additional element selected from the group consisting of a second said storage container system, an exterior panel, or a bottom support panel; and
one or more connector members for connecting the at least one additional element and the storage container system, each connector member comprising:
a U-shaped body having spaced-apart first and second members for receiving portions of walls of the at least one additional element and the sleeve of the storage container system therebetween.
